(19) United States
(12) Patent Application Publication
(10) Pub. No.: US 2013/0126403 A1
(43) Pub. Date: May 23, 2013

(54) AUTOMATED SANTIZATION AND DISINFECTION OF RECREATIONAL AND COMMERCIAL BODIES OF WATER

(71) Applicants: Patrick H. Kilawee, Hugo, MN (US); Leonard J. Kadlec, Woodbury, MN (US); James R. Mock, SR., Mendota Heights, MN (US); Marnie J. Lietz, Eagan, MN (US)

(72) Inventors: Patrick H. Kilawee, Hugo, MN (US); Leonard J. Kadlec, Woodbury, MN (US); James R. Mock, SR., Mendota Heights, MN (US); Marnie J. Lietz, Eagan, MN (US)

(73) Assignee: Ecolab USA Inc., St. Paul, MN (US)

(21) Appl. No.: 13/303,915

(22) Filed: Nov. 23, 2011

(51) Int. Cl. C02F 1/66

(52) U.S. Cl. 210/96.1

(57) ABSTRACT

An automated chemical feeder system maintains sanitizer concentration and pH in a body of water, such as a pool, spa, water feature, or other such body of water, at desired levels. A manifold includes a plurality of inlets, each of which receives the addition of a different chemical product to be added to the pool water. The system connects to the pool circulation system via two injection ports; a pool water sample port and a pool return port. Because the system requires only two injection ports into the pool circulation system, the ease of installation of system may be increased and the time required to install the system may be reduced. In another example, an automated chemical feeder system is adapted to maintain sanitizer concentration and pH in two bodies of water.

### TECHNICAL FIELD

The present disclosure relates to the field of sanitizing and disinfecting of pools, spas, water features or other artificial bodies of water.

### BACKGROUND

Pools, spas, water features, and other such bodies of water (hereinafter referred to simply as “pools”) typically have a circulation system that continually pumps water from the pool through a filter, heater, and sanitizer feed system before returning the water back to the pool. The circulation system helps to maintain sanitary conditions of the pool water. The water passes through the filter to reduce the accumulation of foreign material, such as hair, soil, or solids. The water then passes through the heater, where the water is heated prior to returning to the pool.

In addition to filtering, pool water also requires regular sanitization in order to maintain hygienic conditions. Allowing sanitizer levels to fall out of a specified range can contribute to algae blooms, bacterial breakouts, cloudiness in the water, and chemical imbalances. One method for sanitizing pool water is by adding chlorine or other sanitizer to the pool water. A sanitizer generator is capable of being powered on and off depending on the concentration of sanitizer in the water. When there is a sufficient level of sanitizer in the pool water, the sanitizer generator is powered off and no further sanitizer is added to the pool water. Thus, water circulating through the circulation system is filtered and heated, but the composition of the water is not altered. When the level of sanitizer has fallen to a predetermined level, the sanitizer generator is powered on and additional sanitizer is delivered to the pool until the concentration of sanitizer in the water has reached a desired level.

The pH level of the pool water may affect both the pool's physical construction and the health and wellness of swimmers. The pool water may be tested periodically and the pH levels adjusted either manually or automatically to ensure a healthy and comfortable swimming experience. To adjust the pH of the pool water, an acid, such as muriatic acid or sodium bisulfate, may be added to the pool water until a pH level within a predetermined range (e.g., 7.0 to 7.6) is achieved. In addition, other ancillary products, such as sodium bicarbonate or soda ash (for raising pH of the pool water) flocculating agents or other water clarifiers, algaecides, etc., may also be added to the pool water as necessary or desired.

### SUMMARY

In general, the disclosure relates to automated sanitization and disinfection of recreational and commercial bodies of water, such as swimming pools, spas, water features, etc.

In one example, the disclosure is directed to an automated system for maintaining a body of water, the automated system comprising a sample cell that senses information indicative of a level of sanitizer in the body of water and information indicative of a pH of the body water, a sanitizer generator that produces sanitizer to be delivered to the body of water to maintain the effectiveness of the sanitizer in the body of water, an acid tank that stores acid to be delivered to the body of water to maintain the pH of the body of water, a first injection port that samples water from a circulation system associated with the body of water and that delivers the sampled water to the sample cell, wherein the circulation system circulates water from the body of water through a circulation path and returns the water to the body of water, a manifold comprising a tubular manifold body having a proximal end and a distal, outlet end, the manifold body having a first inlet that receives sanitizer from the sanitizer generator, a second inlet distally positioned with respect to the first inlet that receives the sampled water from the sample cell; and a third inlet distally positioned with respect to the second inlet that receives acid from the acid tank, a second injection port that delivers water from the distal, outlet end of the manifold into the circulation system to be delivered to the body of water, and a controller that analyzes the sensed information indicative of the level of sanitizer in the body of water, analyzes the sensed information indicative of the pH of the body water, and that controls addition of the sanitizer and the acid into the manifold based on the analysis. The sample cell, the sanitizer generator, the controller, the acid tank, and the manifold may be mounted to a frame. The frame may include a wheeled base. The controller may further communicate the sensed information via one or more of one or more of a dial-up connection, a local area network (LAN), a wide area network (WAN), internet, a cell phone network, or a satellite network. The controller may further communicate the sensed information to one or more of a remote computing device, a server computer, a handheld computing device, a laptop computer, a tablet computer, a cell phone, or a pager.

In another example, the disclosure is directed to a system comprising a manifold comprising a tubular manifold body having a proximal end and a distal end, the manifold body further having a first inlet configured to receive sanitizer from a sanitizer generator and a second inlet distally positioned with respect to the first inlet configured to receive acid from an acid tank, the distal end of the manifold body configured to deliver the sanitizer and the acid to a circulation system associated a body of water, and a controller that receives information indicative of a level of sanitizer in the body of water, receives information indicative of a pH of the body water, determines whether the level of sanitizer in the body of water satisfies one or more target sanitizer levels, determines whether the pH of the body of water satisfies one or more target pH levels, controls addition of the sanitizer into the first manifold inlet if the one or more target sanitizer levels are not satisfied, and controls addition of the acid into the second manifold inlet if the one or more target pH levels are not satisfied. The system may further include a sample cell configured to sense the information indicative of a level of sanitizer in the body of water and configured to sense the information indicative of a pH of the body water. The system of claim may further include a first injection port that samples water from the circulation system associated with the body of water and that delivers the sampled water to the sample cell. The manifold body may further include a third inlet distally positioned with respect to the first inlet and proximally positioned with respect to the second inlet configured to receive the sampled water from the sample cell.

The details of one or more examples are set forth in the accompanying drawings and the description below. Other features and advantages will be apparent from the description and drawings, and from the claims.

### BRIEF DESCRIPTION OF DRAWINGS

FIG. 1 is a block diagram illustrating an example automated chemical feeder system and an example pool circulation system.

FIG. 2 is a schematic representation of an example manifold 180.

FIG. 3 is a block diagram illustrating electronic components of an example automated chemical feeder system.

FIGS. 4A and 4B are back and side views, respectively, of an example portable cart-based automated chemical feeder system.

FIG. 5 is a block diagram illustrating an example automated chemical feeder system adapted to control sanitizer and pH levels in two bodies of water.

FIGS. 6A and 6B are back and side views, respectively, of an example portable cart-based automated chemical feeder system for two bodies of water.

### DETAILED DESCRIPTION

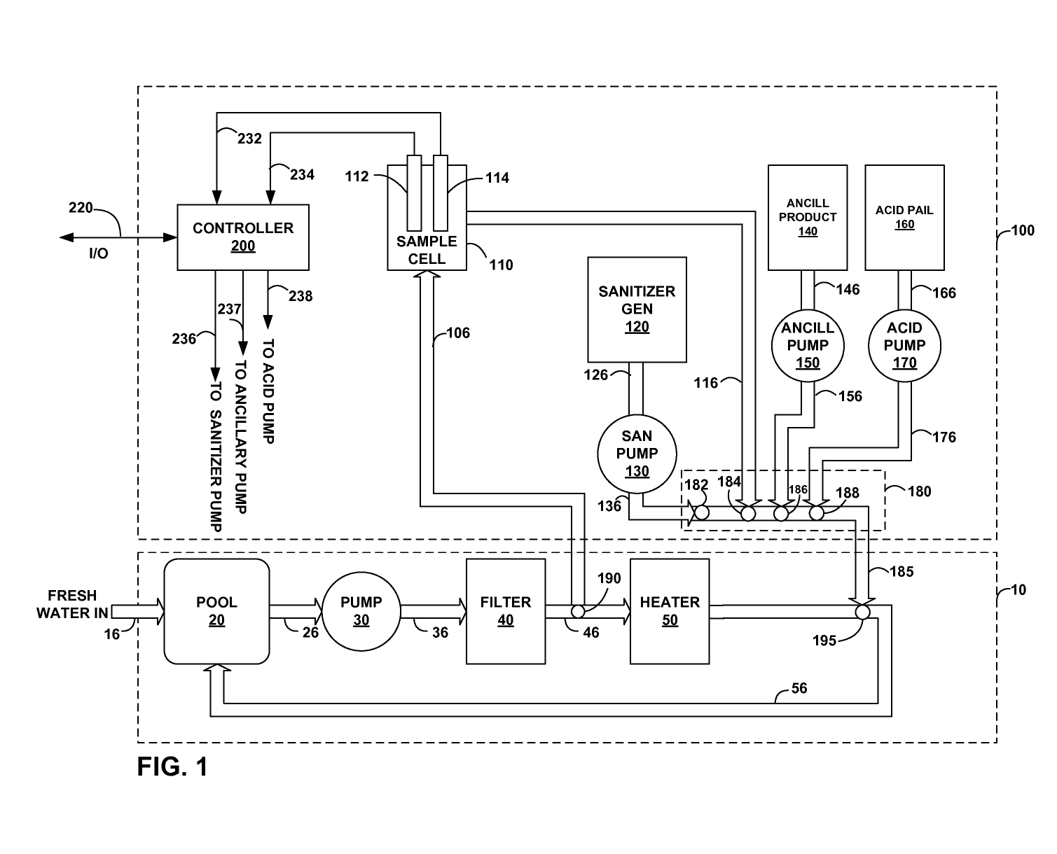

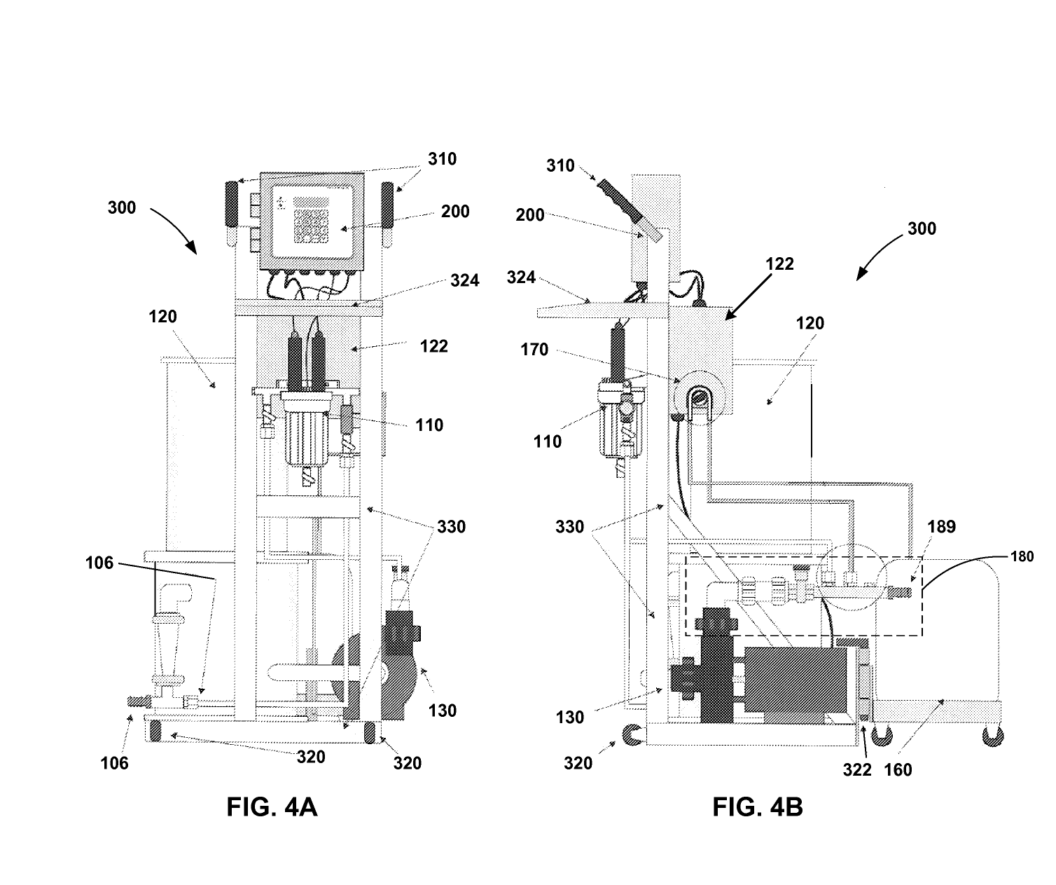

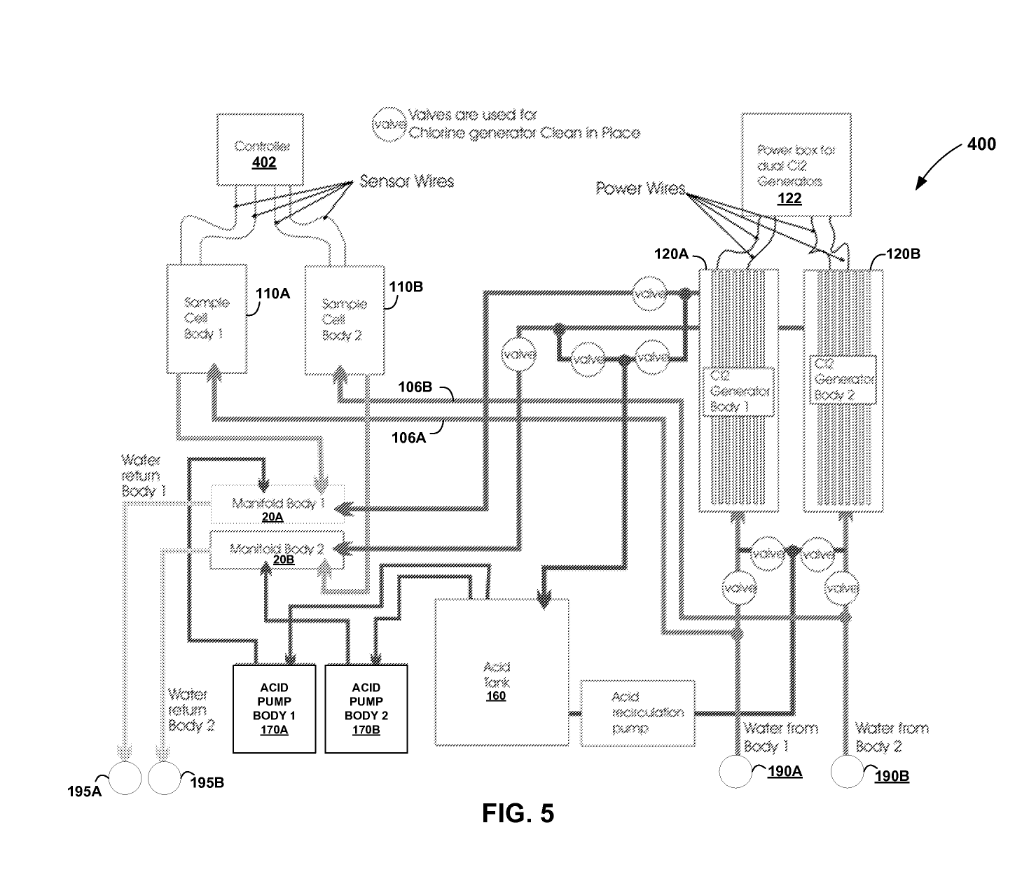

FIG. 1 is a block diagram illustrating an example automated chemical feeder system 100 and an example pool circulation system 10. System 100 maintains the sanitizer concentration and pH in the pool water at desired levels. In this example, system 100 is connected to maintain pool conditions in a single body of water, pool 20. However, it shall be understood that in some examples (such as FIGS. 4, 5A, and 5B discussed below) system 100 may also maintain pool conditions of two or more bodies of water, such as a pool and spa or other combination of bodies of water.

Pool circulation system 10 includes pool 20, a circulation pump 30, a filter 40 and a heater 50 connected via water lines 26 (pool to pump), 36 (pump to filter), 46 (filter to heater), and 56 (return to pool). Fresh water is introduced into pool via fresh water line 16. Circulation pump 30 is typically positioned immediately downstream from pool 20 and pumps water from pool 20 through water line 26.

Automated chemical feeder system 100 includes a sample cell 110, a sanitizer generator 120, a sanitizer pump 130, an ancillary product tank 140, an ancillary product pump 150, an acid storage pail 160, and an acid pump 170.

A controller 200 provides for automated control of system 100. Controller 200 receives information regarding sanitizer and pH levels in the pool water from sample cell 110 via signal lines 232 and 234. Controller 200 controls the addition of sanitizer, ancillary product, and/or acid via control lines 236, 237, and 238 connected to control to sanitizer pump 130, ancillary product pump 150, and acid pump 170, respectively. An external Input/Output (I/O) line(s) 220 permits communication with one or more external electronic devices such as laptop computers, tablet computers, personal digital assistants (PDA), etc. I/O line 220 may also provide for communication with one or more of a Local Area Network (LAN), Wide Area Network (WAN) or the internet. The communication provided by I/O 220 may include one or more wired and/or wireless connections.

System 100 connects to pool circulation system via injection ports 190 (pool water sample port) and 195 (return port). Thus, a technician installing system 100 need only tap into the pool circulation system 10 at two points: in fluid line 46 somewhere between filter 40 and heater 50, and in fluid line 56 after heater 50 and before the pool water is returned to pool 20. Because system 100 requires only two injection ports into circulation system 10, the ease of installation of system 100 may be increased. In addition, the time required to install system 100 may be reduced. Typically system 100 would be installed in or near a pump room or other area associated with the pool site where pool equipment such as filter 40, heater 50, and other pool equipment are located. Injection ports 190 and 195 may be tapped off of lines 46 and 56 in the pump room or other equipment area so that most of the pool equipment, including system 100, may be collocated in a single room or area.

In the example of FIG. 1, first injection port 190 is located at an “upstream” side of heater 50 and second injection port 195 is located at a “downstream” side of the heater.

A manifold 180 receives chemical additives from sanitizer generator 120, ancillary product container 140, and acid pail 160 via manifold inlets 182, 186 and 188, respectively. Pool water from sample cell 110 is delivered to manifold 180 via manifold inlet 184. Manifold 180 collects sanitizer, pool water from sample cell 110, ancillary chemicals and acid in the manifold body 189 (see, e.g., FIG.) and delivers the collected pool water and chemicals to circulation system 10 via injection port 195.

In operation, pool water is sampled from injection port 190 at periodic intervals under control of controller 200. The pool water sample is drawn into sample cell 110. Sample cell 110 includes one or more sensors, such as sensors 112 and 114, that measure, for example, the sanitizer levels of the pool water (112) and/or pH of the pool water (114). The sanitizer level in the pool water may be measured using the oxidation-reduction potential (ORP) of the pool water, the concentration of sanitizer in the pool water, amperometric measurements of the pool water, optical properties of the pool water, or other techniques.

The sanitizer sensor readings from sample cell 110 are sampled periodically by controller 200 and received as a voltage indicative of the sanitizer level in the pool water. Similarly, the pH sensor readings from sample cell 110 are sampled periodically by controller 200 and received as a voltage that is indicative of the pH of the pool water.

Controller 200 calculates the sanitizer level in the pool water (e.g., the ORP, the concentration, etc.) from the sanitizer sensor readings received from sample cell 110. Similarly, controller 200 calculates the pH of the pool water from the pH sensor readings received from sample cell 110.

Controller 200 determines whether the sanitizer levels in the pool water satisfies one or more target sanitizer levels. Controller 200 maintains the levels of sanitizer in the pool water at a target level by controller addition of sanitizer to the pool water as needed via manifold inlet 182. When controller 200 determines that the sanitizer level of the pool water has fallen to a minimum sanitizer level, controller 200 sends a control signal to sanitizer generator 120/sanitizer pump 130 to generate sanitizer and deliver it to the pool water. A concentrated sanitizer solution is then delivered to the pool water via manifold inlet 182. When controller 200 determines that the sanitizer concentration satisfies a target sanitizer level or is within a target sanitizer range, controller 200 instructs sanitizer generator 120 to stop generation of sanitizer (e.g., the sanitizer generator is powered off). Typically, when sanitizer generator 120 is powered off, water flows through sanitizer generator 120 and is injected into manifold inlet 182 but no reaction takes place (and thus no sanitizer is added to the pool water). When controller 200 again determines that sanitizer is needed, sanitizer generator 120 and sanitizer pump 130 are powered on and water containing a concentrated sanitizer solution is injected into pool circulation system 10 via manifold inlet 184.

Sanitizer generator 120 may be implemented using any commercially available or customized sanitizer generator. The sanitizer may include one or more forms of chlorine, or may include alternative pool sanitizers such as salt chlorine generators, ionization-oxidation, ionizers, mineral purifiers, ozone generators, ultraviolet sanitizers, biguanide (e.g., trade names such as Baquacil, Soft-Swim & Revacil), bromine, or other pool sanitizers known in the art. The sanitizing chemicals may take the form of tablets, pellets, grains, sticks, liquids, powder, a gas, or other form factor. One example of a tablet-type sanitizer generator is the PPG 1030 Accu-Tab® Feeder, manufactured by PPG industries, Pittsburgh, Pa., USA. This example sanitizer generator erodes calcium hypochlorite tablets to generate a predetermined amount of chlorine per hour that may then be delivered to the pool water. It shall be understood by those of skill in art, however, that many different types of sanitizers and/or sanitizer generators/pumps may be used, and that the disclosure is not limited in this respect.

Controller 200 determines whether the pH of the pool water satisfies one or more target pH levels. Controller 200 maintains the pH of the pool water at a target level by injecting acid into the pool water via manifold inlet 188. When controller 200 determines that the pH level of the pool water has risen to a maximum pH level, controller 200 sends a control signal to acid pump 170 to pump acid from acid pail 160 into the pool water via manifold inlet 188. When controller 200 determines that the pH level of the pool water is at a target pH level or within a target pH range, controller 200 controls acid pump 170 to stop pumping acid into manifold 180.

Ancillary products, such as such as sodium bicarbonate or soda ash (for raising pH of the pool water) flocculating agents or other water clarifiers, algaecides, etc., may also be added to the pool water as necessary or desired. To control levels of these ancillary products, samples cells may be provided for sensing relevant information from the pool water. Example ancillary product sensors may include a conductivity sensor for sensing salt levels, an alkalinity sensor, etc. Another example may include an optical sensor that can pick up a “marker” (inert material added to but not affecting the ancillary product) that would be sensed optically, such as a florescent additive or a dye.

When controller 200 determines that the sensed ancillary product level of the pool water does not satisfy one or more ancillary product threshold levels, controller 200 sends a control signal to ancillary product pump 150 to pump ancillary product from ancillary product container 140 into the pool water via manifold inlet 186. When controller 200 determines that the ancillary product level of the pool water satisfies one or more target ancillary product levels or is within an ancillary product target range, controller 200 controls ancillary product pump 150 to stop pumping ancillary product into manifold 186.

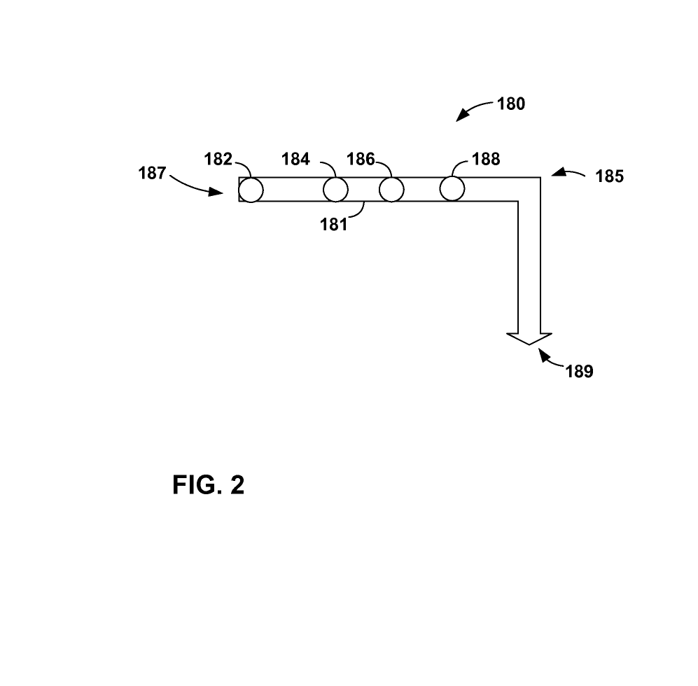

Addition of sanitizer, ancillary product, and/or acid into the pool water may also be controlled manually via a user interface associated with controller 200 (such as user interface 230 as shown in FIG. 2). For example, if a technician determines that sanitizer, ancillary product, and/or acid should be added to the pool water, the technician may enter one or more commands to controller 200 via the user interface. Upon receipt of the command(s), controller 200 instructs sanitizer generator/pump 120/130, ancillary product pump 150, and/or acid pump 170 to generate/add the corresponding chemical product into the pool water. Measurements of desired sanitizer, acid, and/or ancillary product concentration levels or ORP measurements may be manually requested via the user interface.

FIG. 2 is a schematic representation of an example manifold 180. In this example, manifold 180 is formed as a chamber or pipe with several inlets for receiving various chemical products to be delivered into the pool water. Example manifold 180 includes a tubular manifold body 181 having a proximal end 187 and a distal (outlet) end 189, and having a plurality of manifold inlets 182, 184, 186, and 188 serially arranged from the proximal end 187 to the distal end 188. Manifold inlet 182 (sanitizer inlet) is positioned closest to the proximal end 187 of manifold body 181. Manifold inlet 184 (pool water return from sample cell) is positioned distally along manifold body 181 with respect to manifold inlet 182. Manifold inlet 186 (ancillary product inlet) is positioned distally along manifold body 181 with respect to manifold inlet 184. Manifold inlet 188 (acid inlet) is positioned distally along manifold body 181 with respect to manifold inlet 186, and is thus closest to the distal end 189 of manifold body 181 in this example. Manifold 180 may include one or more corners or bends, such as bend 185, to accommodate connection to the pumps 130, 150, 170, or other parts of system 100, or to injection port 195.

In general, the manifold inlet arrangement on manifold body 181 is determined at least in part by the chemical(s) to be collected by the manifold. For example, the sample cell manifold inlet 184 should generally be positioned proximally along the manifold body with respect to the acid inlet 188 so that acid injected into the manifold 180 does not flow back into the sample cell and damage the probes. For this reason, and to prevent other possible damage to parts of system 100, acid manifold inlet 188 should typically be the last point of injection into manifold body 181. The sample cell inlet 184 is positioned distally from the sanitizer inlet 182 and ancillary products (such as clarifiers, U.V. stabilizers, phosphate removers, etc.) can be injected into ancillary product inlet 186. The distal end 189 of manifold body 181 fluidly connects to injection port 195, thus delivering sampled pool water and any added chemicals to the pool water in the pool circulation system 10.

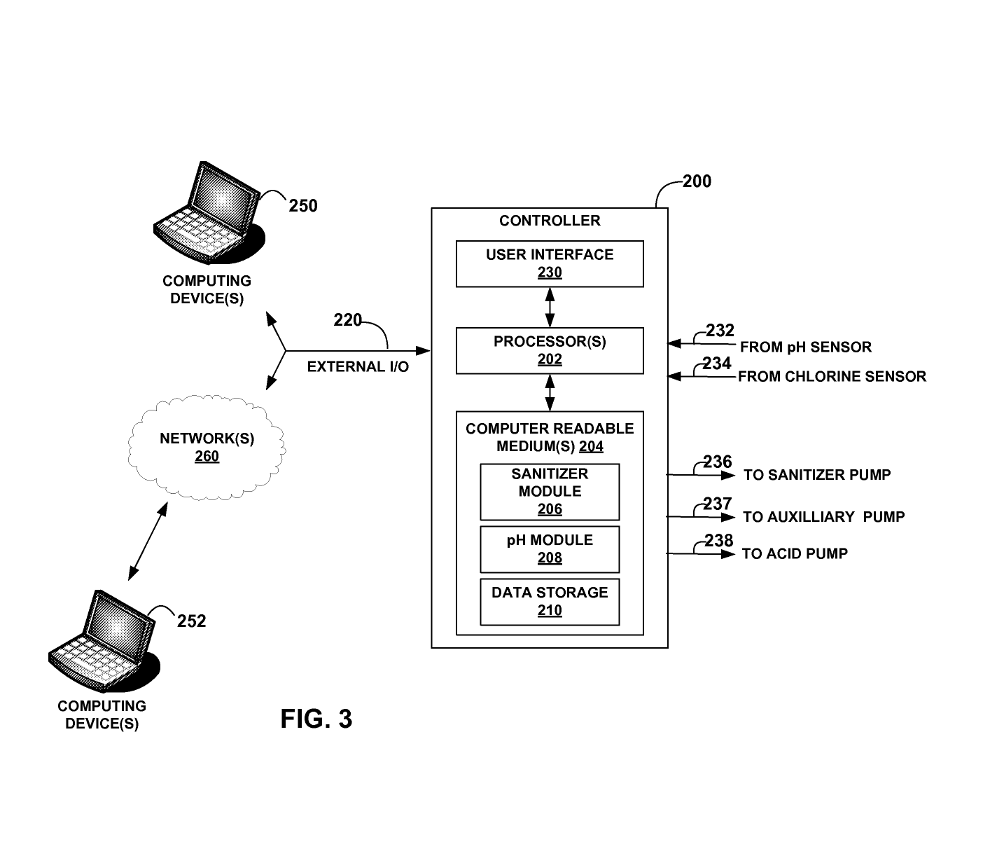

FIG. 3 is a block diagram illustrating the electronic components of an example automated chemical feeder system 100. Controller 200 includes one or more processors 202 that execute one or more software modules that control the various functions of system 100. One or more computer readable medium(s) 204 store one or more software modules such as a sanitizer module 206 and a pH module 208. Sanitizer module 206 includes instructions for determining levels associated with the amount of sanitizer in the pool water, such as the ORP or the sanitizer concentration of the pool water; determining whether the sanitizer levels satisfy one or more target sanitizer levels; and for controlling addition of sanitizer into the pool water. Sanitizer module 206 may further include instructions for analyzing the sanitizer data and/or generating reports concerning the sanitizer data. pH module 206 includes instructions for determining levels associated with the pH level of the pool water; determining whether the pH levels satisfy one or more target pH levels; and for controlling addition of acid to adjust the pH of the pool water. pH module 206 may further include instructions for analyzing the pH data and/or generating reports concerning the pH data. Similarly, an ancillary product module (not shown) may control addition of one or more ancillary products into the pool water, analyze any ancillary product data and generate reports based on the analysis of the ancillary product data.

Data storage 210 stores data received or generated by controller 200 during operation of system 100. For example, data storage 210 may include system parameters such as target sanitizer, pH, ORP, ancillary product, or other target levels concerning the pool water. Data storage 210 may also include any data received or generated by controller 200 during operation of system 100, such as raw data from sample cell 120; sanitizer, pH, ORP, ancillary product, or other chemical levels concerning the pool water; including data generated by any analysis that may be performed on the pool water data, etc. Data storage may further store information concerning times at which various chemical products were added to the pool water and/or how much of the various chemical products were added to the pool water. Data storage 210 may also store one or more reports concerning the results of the analysis.

User interface 230 permits a service technician or other user to interact with system 100. For example, user interface 230 may display information concerning the sanitizer or pH levels of the pool water. User interface 230 may also display information or reports concerning the times at which various chemical products were added to the pool water by system 100 and/or the amounts of the various chemical products that were added to the pool water by system 100. As another example, user interface may permit a user to enter commands requesting data from the system 100, or to manually control addition of one or more chemicals by system 100 into the pool water. To those and other ends, user interface 230 may include one or more of a keyboard, a mouse or other selection device, a display, a touch screen, speakers, microphone, camera, video camera, or other appropriate user interface device.

External I/O connection(s) 220 provides for one or more types of external communication with controller 200. For example, connection 220 may provide for wired or wireless communication via one or more of one or more networks 260, such as a local area network (LAN), a wide area network (WAN), the internet, a cell phone network, a satellite network, etc. Connection 220 may also provide for wired or wireless connection to one or more computing devices 250, such as a remote computing device, a server computer, a handheld computing device, a laptop computer, a tablet computer, a cell phone, a pager, etc. Such devices, such as computing devices 252 may also communicate with controller 200 via one or more of networks 260. Controller 200 may receive instructions, commands, software updates, etc., via connection(s) 220. Controller may also communicate any sensed information concerning the effectiveness of the sanitizer in the water or the pH of the water via connection(s) 220. Controller may further communicate any data, reports, or alarms generated by analysis of the sensed information via connection(s) 220.

One or more of computing devices 250 and/or 252 may also include additional analysis or reporting applications for further analysis and reporting of the data received from controller 200. For example, a computing device such as computing device 252 may receive data from a plurality of system controllers 200, each associated with a different one of a plurality of pools. In this way, a computing device 252 may analyze data from multiple pools or accounts, compare and contrast results, compute averages, determine chemical product amounts dispensed and times dispensed, monitor inventory, etc., and may thus permit a user to manage a plurality of pool sites from one or more remote locations.

FIGS. 4A and 4B are back and side views, respectively, of an example portable cart-based automated chemical feeder system 300. In this example, cart-based system 300 includes the components described above with respect to system 100 of FIG. 1 mounted onto a wheeled frame 330. Controller 200 is mounted near the top of frame 330 to permit ease of interaction for a service technician or other users. Handles 310 and wheels 320 permit cart-based system 300 to be moved relatively easily from place to place as needed. A removable utility shelf/sun shade 324 may also be mounted to frame 330.

Sample cell 110, sanitizer generator 120, sanitizer pump 130, and acid pump 170 are also mounted onto frame 330 in this example. Acid pail 160 may be removably connected to frame 330 via a lockdown latch 322. Latch 322 permits acid pail 160 to be replaced with a new acid pail when the supply of acid runs out. A power box 122 provides power to controller 200, sample cell 110, sanitizer generator 120, sanitizer pump 130, ancillary product pump 150, acid pump 170, and any other components requiring electrical power.

When installed, fluid line 106 would be fluidly connected to injection port 190 so as to receive pool water from pool circulation system 10. Distal end 189 of manifold 180 would be fluidly connected to injection port 195 so that system 300 may control addition of one or more chemical products into the pool circulation system 10.

FIG. 5 is a block diagram illustrating an example automated chemical feeder system 400 adapted to control sanitizer and pH levels in two bodies of water, 20A and 20B. In this example, body of water 20A may be a pool and body of water 20B may be a spa. However, bodies of water 20A and 20B may be any combination of bodies of water, and the disclosure is not limited in this respect.

Two sample cells 110A and 110B, each corresponding to one of bodies of water 20A and 20B, respectively, receive water from injection ports 190A and 190B along fluid lines 106A and 106B. Sanitizer generators 120A and 120B generate sanitizer for bodies of water 20A and 20B, respectively. An acid tank 160 stores acid to be added to control the pH of the bodies of water 20A and 20B. An acid pump 170A and an acid pump 170B control addition of the acid into the bodies of water 20A and 20B, respectively. A controller 402 receives information concerning the levels of sanitizer and the pH of the bodies of water 20A and 20B from the sample cells 110A and 11B as described above with respect to FIG. 1. Controller 402 controls addition of sanitizer and acid to the bodies of water by controlling sanitizer generators 120A and 120B and acid pumps 170A and 170B.

System 402 may include a dual generator, single power source that uses a single power both first and second sanitizer generators 120A and 120B. In this way, a single power source may be used to generate sanitizer for two bodies of water, which may reduce the cost of maintaining such systems. An example dual generator single power source for tandem pool and spa is described in commonly assigned U.S. Pat. No. 7,736,522, issued Jun. 15, 2010, which is incorporated herein by reference in its entirety. However, it shall be understood that any type of power arrangement may be used, and that the disclosure is not limited in this respect.

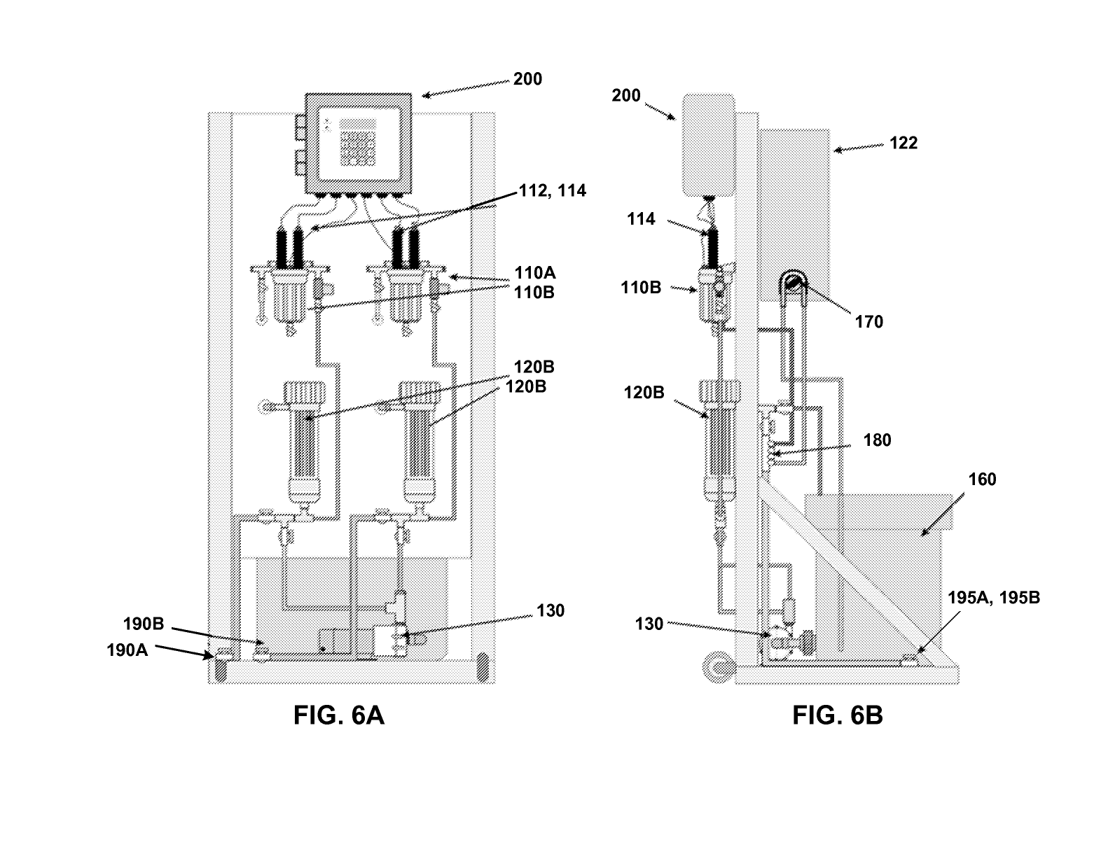

FIGS. 6A and 6B are front and side views, respectively, of an example portable cart-based automated chemical feeder system for two bodies of water 20A and 20B. Bodies of water 20A and 20B may be, for example, a pool and a spa collocated at a single site, or other combination of bodies of water. As in FIGS. 4A and 4B, cart-based system 400 includes the components described above with respect to system 100 mounted onto a wheeled frame 330. Controller 200 is mounted near the top of frame 330 to permit ease of interaction for a service technician or other users. Sample cells 110A and 110B (one for each body of water 20A and 20B, respectively), sanitizer generators 120A and 120B (one for each body of water 20A and 20B, respectively), and acid pump 170 are also mounted onto frame 330 in this example. Acid pail 160 may be removably connected to frame 330 as described with respect to FIGS. 4A and 4B. A power box 122 provides power to sanitizer generators 120A and 120B. When installed, fluid line 106A would be fluidly connected to injection ports 190A (from water body 20A) so as to receive pool water from a water body circulation system 10A. Similarly, fluid line 106B would be fluidly connected to injection ports 190B (from water body 20B) so as to receive pool water from a water body circulation system 10B.

System 400 includes two manifolds 180A and 180B, each corresponding to one of water bodies 20A and 20B, respectively. Distal end 189A of manifold 180A would be fluidly connected to injection port 195A so that system 400 may control addition of one or more chemical products into the pool circulation system 10A. Similarly, distal end 189B of manifold 180B would be fluidly connected to injection port 195B so that system 400 may control addition of one or more chemical products into the pool circulation system 10B.

In some examples, the automated chemical feeder systems and techniques described herein may encompass one or more computer-readable media comprising instructions that cause a processor, such as processor(s) 202, to carry out the techniques described above. A “computer-readable medium” includes but is not limited to read-only memory (ROM), random access memory (RAM), non-volatile random access memory (NVRAM), electrically erasable programmable read-only memory (EEPROM), flash memory a magnetic hard drive, a magnetic disk or a magnetic tape, a optical disk or magneto-optic disk, a holographic medium, or the like. The instructions may be implemented as one or more software modules, which may be executed by themselves or in combination with other software. A “computer-readable medium” may also comprise a carrier wave modulated or encoded to transfer the instructions over a transmission line or a wireless communication channel. Computer-readable media may be described as “non-transitory” when configured to store data in a physical, tangible element, as opposed to a transient communication medium. Thus, non-transitory computer-readable media should be understood to include media similar to the tangible media described above, as opposed to carrier waves or data transmitted over a transmission line or wireless communication channel.

The instructions and the media are not necessarily associated with any particular computer or other apparatus, but may be carried out by various general-purpose or specialized machines. The instructions may be distributed among two or more media and may be executed by two or more machines. The machines may be coupled to one another directly, or may be coupled through a network, such as a local access network (LAN), or a global network such as the Internet.

The automated chemical feeder system may also be embodied as one or more devices that include logic circuitry to carry out the functions or methods as described herein. The logic circuitry may include a processor that may be programmable for a general purpose or may be dedicated, such as microcontroller, a microprocessor, a Digital Signal Processor (DSP), an Application Specific Integrated Circuit (ASIC), a field programmable gate array (FPGA), and the like.

One or more of the techniques described herein may be partially or wholly executed in software. For example, a computer-readable medium may store or otherwise comprise computer-readable instructions, i.e., program code that can be executed by a processor to carry out one of more of the techniques described above. A processor for executing such instructions may be implemented in hardware, e.g., as one or more hardware based central processing units or other logic circuitry as described above.

Various examples have been described. These and other examples are within the scope of the following claims.

1. An automated system for maintaining a body of water, the automated system comprising:
a sample cell that senses information indicative of a level of sanitizer in the body of water and information indicative of a pH of the body water;
a sanitizer generator that produces sanitizer to be delivered to the body of water to maintain the effectiveness of the sanitizer in the body of water;
an acid tank that stores acid to be delivered to the body of water to maintain the pH of the body of water;
a first injection port that samples water from a circulation system associated with the body of water and that delivers the sampled water to the sample cell, wherein the circulation system circulates water from the body of water through a circulation path and returns the water to the body of water;
a manifold comprising:
a tubular manifold body having a proximal end and a distal, outlet end, the manifold body having a first inlet that receives sanitizer from the sanitizer generator, a second inlet distally positioned with respect to the first inlet that receives the sampled water from the sample cell; and a third inlet distally positioned with respect to the second inlet that receives acid from the acid tank;
a second injection port that delivers water from the distal, outlet end of the manifold into the circulation system to be delivered to the body of water; and
a controller that analyzes the sensed information indicative of the level of sanitizer in the body of water, analyzes the sensed information indicative of the pH of the body water, and that controls addition of the sanitizer and the acid into the manifold based on the analysis.

2. The system of claim 1 wherein the sample cell, the sanitizer generator, the controller, the acid tank, and the manifold are mounted to a frame.

3. The system of claim 2 wherein the acid tank is removably mounted to the frame.

4. The system of claim 2 wherein the frame includes a wheeled base.

5. The system of claim 2 wherein the frame includes one or more handles positioned near a top end of the frame.

6. The system of claim 1 wherein the controller further communicates the sensed information via one or more of one or more of a dial-up connection, a local area network (LAN), a wide area network (WAN), internet, a cell phone network, or a satellite network.

7. The system of claim 1 wherein the controller further communicates the sensed information to one or more of a remote computing device, a server computer, a handheld computing device, a laptop computer, a tablet computer, a cell phone, or a pager.

8. The system of claim 7 wherein the communication is one or more of a wired communication or a wireless communication.

9. The system of claim 1 further comprising:
an ancillary product tank that stores an ancillary product to be delivered to the body of water,
the manifold body further having a fourth inlet distally positioned with respect to the second inlet and proximally positioned with respect to the third inlet, wherein the fourth inlet receives ancillary product from the ancillary product tank, and
wherein the controller further analyzes the sensed information indicative of the level of the ancillary product in the body of water and controls addition of the ancillary product into the manifold based on the analysis.

10. The system of claim 1 wherein the information indicative of a level of sanitizer in the body of water includes one of an oxidation-reduction potential (ORP) of the sampled water, a concentration of sanitizer in the sampled water, an amperometric measurement of the pool water, or an optical property of the sampled water.

11. The system of claim 1 wherein the circulation system includes a filter and a heater, and wherein the first injection port samples water from an upstream side of the heater and the second injection port delivers water and chemical products to a downstream side of the heater.

12. A system comprising:
a manifold comprising a tubular manifold body having a proximal end and a distal end, the manifold body further having a first inlet configured to receive sanitizer from a sanitizer generator and a second inlet distally positioned with respect to the first inlet configured to receive acid from an acid tank, the distal end of the manifold body configured to deliver the sanitizer and the acid to a circulation system associated a body of water; and
a controller that receives information indicative of a level of sanitizer in the body of water, receives information indicative of a pH of the body water, determines whether the level of sanitizer in the body of water satisfies one or more target sanitizer levels, determines whether the pH of the body of water satisfies one or more target pH levels, controls addition of the sanitizer into the first manifold inlet if the one or more target sanitizer levels are not satisfied, and controls addition of the acid into the second manifold inlet if the one or more target pH levels are not satisfied.

13. The system of claim 12 further comprising a sample cell configured to sense the information indicative of a level of sanitizer in the body of water and configured to sense the information indicative of a pH of the body water.

14. The system of claim 13 further comprising a first injection port that samples water from the circulation system associated with the body of water and that delivers the sampled water to the sample cell.

15. The system of claim 14 wherein the manifold body further includes a third inlet distally positioned with respect to the first inlet and proximally positioned with respect to the second inlet configured to receive the sampled water from the sample cell.

16. The system of claim 13 wherein the sample cell, the sanitizer generator, the controller, the acid tank, and the manifold are mounted to a frame.

17. The system of claim 16 wherein the acid tank is removably mounted to the frame.

18. The system of claim 16 wherein the frame includes a wheeled base.

19. The system of claim 12 wherein the controller further stores information concerning one or more of the level of sanitizer in the body of water, the pH of the body water, whether the level of sanitizer in the body of water satisfies one or more target sanitizer levels, whether the pH of the body of water satisfies one or more target pH levels, an amount of sanitizer added to the body of water, or an amount of acid added to the body of water.

20. The system of claim 19 wherein the controller further communicates some or all of the stored information to one or more of a remote computing device, a server computer, a handheld computing device, a laptop computer, a tablet computer, a cell phone, or a pager.
